(19) United States
(12) Patent Application Publication
(10) Pub. No.: US 2006/0030316 A1
(43) Pub. Date: Feb. 9, 2006

(54) Advance viewing of subscriber profile in a communication system

(75) Inventor: Noam Ishak Lando, Hod-Hasharon (IL)

Correspondence Address: FARSHAD JASON FARHADIAN;CENTURY IP LAW GROUP, P.O. BOX 7333, NEWPORT BEACH, CA, 92658-7333, US

(73) Assignee: IXI Mobile (R&D) Ltd.

(21) Appl. No.: 10/913,643

(22) Filed: Aug. 5, 2004

(51) Int. Cl. H04Q 7/20

(52) U.S. Cl. 455/432.3; 455/461; 455/432.1

(57) ABSTRACT

A method of communicating with a subscriber of a communication service is provided. The method comprises processing contact information provided to a first communication device for establishing a communication connection with a second communication device used by the subscriber; accessing the subscriber's profile information based on the provided contact information; and determining an availability status for the subscriber based on the profile information, wherein the profile information is updated in real-time in accordance with at least the subscriber's interaction with the second communication device.

### BACKGROUND

1. Field of Invention

The present invention relates generally to communication services and, more particularly, to a system and method for automatically updating a mobile communication subscriber's profile.

2. Copyright & Trademark Notices

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

3. Related Art

Communication devices, particularly mobile communication devices and the related services provide the convenience and the possibility for communicating information at any time from almost anywhere. A disadvantage associated with the use of mobile devices is that a user can be interrupted at by a caller at times that are not convenient for the user.

To avoid interruptions, a user can turn his device off. This would mean, however, that the user would not be able to receive a call or message even if it is of urgent nature. Certain device models allow the user to set the device to a quiet or a meeting mode. This mode change reduces the level of interruption by limiting the device to vibrate or emit a light signal, instead of producing a ring tone. This is less than a perfect solution.

It would be preferable for a communication subscriber to provide his availability status or profile information to a calling party in advance of the calling party initiating the communication. In this manner, the calling party will have the discretion of waiting to contact the subscriber at a later time, if the subscriber profile indicates that the subscriber is not available or does not want to be interrupted.

For the above reasons, a method and system is needed that can provide a subscriber's profile information to a calling party, wherein the profile information indicates, in advance, whether the subscriber is available for communication.

### SUMMARY

One or more embodiments of the present invention are directed to a method of updating a subscriber's profile information in a communications network. The method comprises monitoring changes in the profile information of the subscriber and transmitting subscriber profile information to a server system, in response to detecting a first change in the status of the subscriber, wherein the subscriber profile information indicates if or when the subscriber is available for communication.

For purposes of summarizing, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

In one embodiment, a method for communicating with a subscriber of a communication service is provided. The method comprises processing contact information provided to a first communication device for establishing a communication connection with a second communication device used by the subscriber; accessing the subscriber's profile information based on the provided contact information; and determining an availability status for the subscriber based on the profile information, wherein the profile information is updated in real-time in accordance with at least the subscriber's interaction with the second communication device.

The method may further comprise establishing a connection between the first and second communication devices, when the subscriber is available according to the determined availability status of the subscriber; providing an option to send a status update to the first communication device, if the subscriber is unavailable according to the determined availability status of the subscribe; monitoring the availability status of the subscriber in real-time; and sending a status update to the first communication device, when the subscriber becomes available according to a change in the availability status of the subscriber.

In one embodiment, a communication connection is established with the second communication device, when the availability status of the subscriber changes from unavailable to available. The first or second communication devices may comprise a mobile communication device. The subscriber's profile information is stored in the second communication device or in a database accessible by the first communication device. The subscriber's profile information can be edited by the subscriber.

In another embodiment, a mobile communication system is provided. The mobile communication system comprises means for processing contact information for establishing a communication connection with a remote communication device used by the subscriber; means for accessing the subscriber's profile information based on the provided contact information; and means for determining an availability status for the subscriber based on the profile information, wherein the profile information is updated in real-time in accordance with at least the subscriber's interaction with the remote communication device.

In certain embodiments, the mobile communication system further comprises means for establishing a connection with the remote communication devices, when the subscriber is available according to the determined availability status of the subscriber; means for providing an option to receive a status update, if the subscriber is unavailable according to the determined availability status of the subscriber; means for monitoring the availability status of the subscriber in real-time; and means for receiving a status update, when the subscriber becomes available according to a change in the availability status of the subscriber.

The mobile communication system may further comprise means for establishing a communication connection with the remote communication device, when the availability status of the subscriber changes from unavailable to available.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

Embodiments of the present invention are understood by referring to the figures in the attached drawings, as provided below.

FIG. 1 illustrates an exemplary communications environment in accordance with one or more embodiments of the invention;

FIG. 2 is a flow diagram of a method for updating a subscriber's profile in a communications network, in accordance with one or more embodiments; and

FIGS. 3A and 3B are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION

An electronic system and corresponding methods, according to an embodiment of the present invention, facilitate and provide an automatic real-time update system for providing a third party with a subscriber's profile in advance of establishing a communication connection with the subscriber.

The terms electronic services, services, and online services are used interchangeably herein. The services provided by the system of this invention, in one or more embodiments, are provided by a service provider. A service provider is an entity that operates and maintains the computing systems and environment, such as server systems and infrastructure that enable the delivery of information and services. Typically, server architecture comprises of components (e.g., hardware, software, and communication lines) that store and offer electronic or online data and voice communication services.

In the following, numerous specific details are set forth to provide a thorough description of various embodiments of the invention. Certain embodiments of the invention may be practiced without these specific details or with some variations in detail. In some instances, features not pertinent to the novelty of the system are described in less detail so as not to obscure other aspects of the invention.

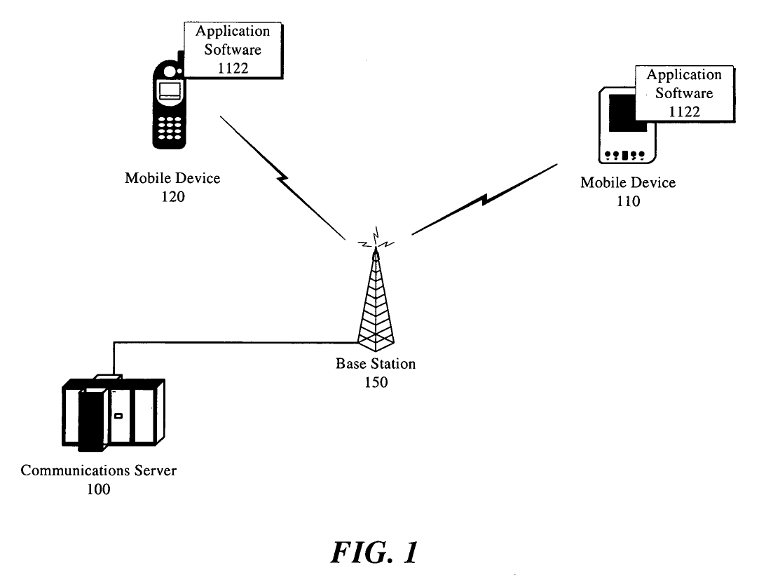

Referring to the drawings, FIG. 1 illustrates an exemplary communications environment in which the system of the present invention may operate. In accordance with one aspect of the system, the environment comprises plurality of mobile devices 110, 120 that communicate with a communications server 100, via a base station 150, for example. In the following, exemplary embodiments of the invention are described as applicable to wireless mobile communication services. It should be noted, however, that this application is by way of example. As such, the systems and methods provided herein may be applied landline telephony systems or in any wired or wireless communication environment.

Communications server 100, in accordance with one embodiment, provides data messaging services (e.g., instant messaging, short messaging, etc.), and may comprise or is coupled to one or more databases (not shown) to update and store one or more subscriber profiles. The terms “connected,” “coupled,” or any variant thereof, mean any connection or coupling, either direct or indirect, between two or more elements. The coupling or connection between the elements can be physical, logical, or a combination thereof.

In one embodiment, communications server 100 communicates with mobile devices 110, 120 connected in the communications network illustrated in FIG. 1. The communications network provides the medium and infrastructure (i.e., base station 150) for transmitting digital or analog voice and data signals between communications server 100 and mobile devices 110, 120. In certain embodiments, mobile devices 110, 120 are cellular telephones communicating in a cellular telephone network, for example. Mobile devices 110, 120, and communications server 100, however, may be implemented to communicate over any type of mobile, fixed, wired or wireless communications network.

One of ordinary skill in the art would appreciate that the communications network of the invention may advantageously be comprised of one or a combination of various types of networks without departing from the scope of the invention. For example, in some embodiments, the communications network can comprise local area networks (LANs), wide area networks (WANs), public, private or secure networks, value-added networks, interactive television networks, wireless communications networks, two-way cable networks, satellite networks, interactive kiosk networks, cellular networks, personal mobile gateways (PMGs) and/or any other suitable communications network or part of the world wide web (i.e., the Internet).

In either context, mobile devices 110, 120 can communicate with a service provider to send and receive electronic packets of information, in form of electronic requests and responses. In one embodiment, the service provider is a wireless communications service provider (e.g., Sprint, AT&T or Verizon) to which a mobile user may subscribe.

Some of the services provided by the system of the present invention may be implemented as application software 1122 installed and executed on mobile devices 110, 120, as provided in further detail below. In certain embodiments, application software 1122 executed on mobile devices 110, 120 can act as client software that is in communication with communications server 100 or a service provider, for example.

In some embodiments, mobile devices 110, 120 may comprise a PMG device or communicate with a PMG device. The PMG architecture comprises a PMG server that can wirelessly communicate with a number of PMG enabled devices within the personal area of the user, thus providing a personal area network (PAN).

In addition, the PMG server can wirelessly communicate with remote server systems, such as a service provider or communications server 100, via a wireless system or communications network in a WAN. Thus, the PMG acts as an interface to seamlessly connect a PAN to a WAN, and as such the devices attached to the PAN or WAN can communicate with each other. A more detailed description of the PMG architecture is provided in U.S. patent application Ser. No. 09/850,399, filed on May 07, 2001, the entire content of which is hereby incorporated by reference here.

As used herein, the terms mobile device, service provider, communications server and communications network are to be viewed as designations of one or more computing environments that comprise application, client or server software for servicing requests submitted by respective software included in mobile devices or other computing systems connected thereto. These terms are not to be otherwise limiting in any manner. Application software 1122, for example, may be comprised of one or more modules that execute on one or more computing systems, as provided in further detail below.

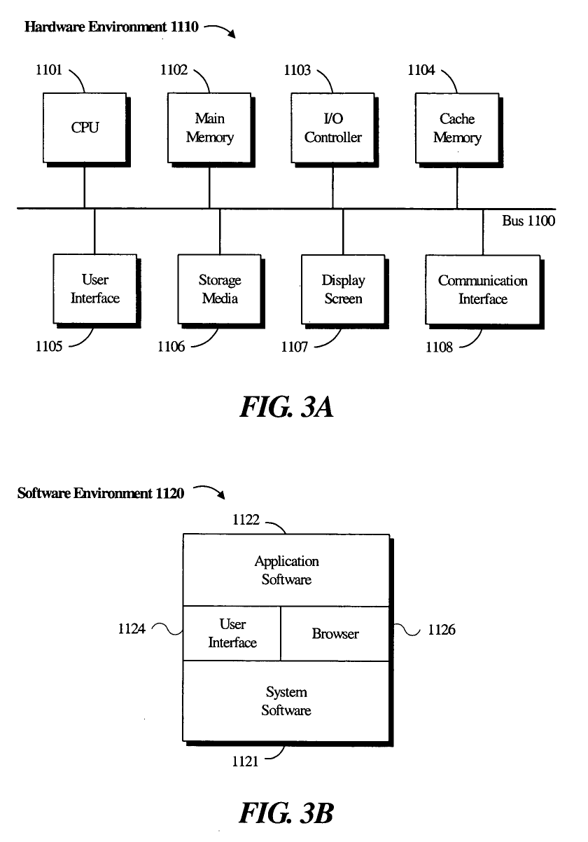

Referring to FIGS. 1 and 3A, in accordance with one aspect of the invention, application software 1122 may be implemented on a device or system other than mobile device 110. For example, application software 1122 or its components may be implemented, installed, and executed either in a singular or in a distributed environment. Certain components of the application software 1122 may be installed and executed on mobile devices 110, 120 while other components may be executed and installed on, for example, a PMG device, communications server 100, internet portals, service provider server systems, a telephony switching system or other computer systems and networks attached thereto to determine, update and/or report a subscriber's profile information.

The subscriber profile information as used herein refers to a set of data stored on either mobile device 110, communications server 100, or other devices attached thereto. This information indicates the preference of a subscriber for communicating with other devices in a communication network. As such, a subscriber may interact with mobile device 110 or other devices connected to communications server 100, for example, to edit his or her profile information.

The profile information may include a variety of fields or indicators, for example, defining subscriber preferences, personal information, or other data about the subscriber. An exemplary subscriber profile structure is provided in Table 1.

TABLE 1

| Field | Status |
|---|---|
| Device On | 0 or 1 |
| In Meeting | 0 or 1 |
| Away | 0 or 1 |
| At work | 0 or 1 |
| On the Phone | 0 or 1 |

Referring to Table 1, a subscriber can edit the subscriber profile according to his preference. A subscriber profile may be also automatically updated according to the status of mobile device 110 being used by the subscriber. If a subscriber's profile information provides that the value for the “In Meeting” field is one, for example, then when the subscriber profile is accessed by a third party, application software 1122 executing on the third party's device will interpret that to mean that the subscriber is in a meeting and will produce an audio or visual alert on the third party's device. If the value for the respective field is zero, then the field related information would not be displayed on the third party's device.

In one embodiment, when a third party or a caller attempts to communicate with the subscriber by, for example, dialing the subscriber's phone number or selecting the subscriber's name from mobile device 110's memory, the profile information for the subscriber is automatically displayed on mobile device 110's screen. Accordingly, the caller can immediately determine the availability status or preference of the subscriber by viewing the subscriber's profile.

In certain embodiments, the subscriber may advantageously utilize application software 1122 executing on his or her mobile device 120 to set one or more conditions for the profile information. For example, if the subscriber works between the hours of 8 am to 5 pm, the subscriber may set the profile information to indicate that he or she is at work between said hours. In this manner, when a caller attempts to communicate with the subscriber during the noted specified hours, the caller would know that the subscriber is at work and should not be interrupted.

In another embodiment, a subscriber may set his or her profile information to include his email address, or other text messaging contact information, for example, so that if the subscriber is unavailable to receive voice communication, a caller can send the subscriber a text message instead. Other implementation of the combination of text or voice messaging may be adopted in various embodiments of the invention.

It should be noted that the exemplary embodiments disclosed above are not to be construed to limit the scope of the invention to application software 1122 that is exclusively executed on mobile device 110, or a system that exclusively operates to provide real-time support for updating subscriber profile information. Other status information or data may be also updated according to the technological advantages that are the subject matter of this invention.

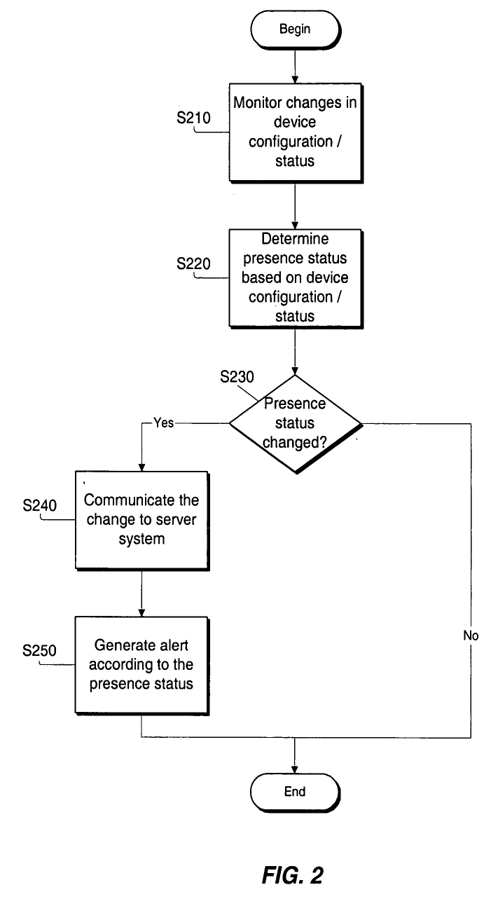

Referring to FIGS. 1 and 2, in accordance with one aspect of the invention, a caller may utilize mobile device 110 to communicate with a subscriber's mobile device 120. Before the caller initiates the communication connection (e.g., when the phone number is dialed, or when subscriber's name is selected from memory of mobile device 110), application software 1122 running on mobile device 110 submits a request to receive subscriber profile information (S210).

Depending on implementation and the location of storage of the subscriber's profile, the request can be submitted from mobile device 110 to one or more computing systems, where the subscriber's profile is stored. In some embodiments, the subscriber's profile is stored on mobile device 120. Alternatively, the subscriber's profile may be stored on other systems (e.g., communications server 100, a third party portal, a database server, a service provider, etc.) to which mobile device 110 is directly or indirectly connected.

Accordingly, mobile device 110 submits a request to retrieve the needed subscriber's profile information from mobile device 120 or other computing systems. In some embodiments, the subscriber's profile information may be stored in a dedicated profile server that is accessible by mobile devices 110 or 120. In any event, the submitted request is processed by the appropriate computing system (e.g., communications server 100) and a response including the subscriber's profile information is provided to mobile device 110.

Based on the provided response, application software 1122 running on mobile device 110 determines the availability status of the subscriber (S220). As noted earlier, the subscriber's profile information may be provided based on profile information inputted by the subscriber by way of editing his or her personal profile stored in a database or by way of the subscriber interaction with mobile device 120.

For example, the subscriber may connect to an Internet portal to create or update his profile information. Alternatively, the subscriber's profile information may be automatically updated when the subscriber changes mobile device 120's configuration by selecting a vibration mode. If so, application software 1122 running on mobile device 120 will detect this change in device settings and update the subscriber's profile to indicate that the subscriber is in a meeting, for example. Further, the subscriber's profile may be updated, if the subscriber uses mobile device 120 to make a phone call. That is, in such a case, application software 1122 will update the subscriber's profile to indicate that the subscriber is on the phone, for example.

Accordingly, when the subscriber is engaged in a communication session or is otherwise unavailable, the user profile is updated to reflect the availability status of the subscriber. Thus, before a caller attempts to establish a communication with the subscriber, application software 1122 can check the user profile information to determine if the subscriber is available (S230).

If the subscriber is available, then application software 1122 establishes a communication connection between mobile device 110 and mobile device 120 (S240). Otherwise, a communication connection is not established, but the caller is given the option of proceeding with establishing a connection. That is, the subscriber profile information may indicate that the user is in a meeting, away, at work, or on the phone. The caller may then use his or her discretion to proceed with establishing a communication.

For example, if the caller needs to communicate important or urgent information to the subscriber, then the caller may decide to proceed with completing the call, even though it may not be a convenient time for the subscriber. Thus, advantageously, the caller is given the option to compete the call or wait for a better or more convenient time. If the caller decides to wait, in some embodiments, application software 1122 is implemented to prompt the caller with the option to receive a status update in the future, if the availability of the subscriber changes. If so, application software 1122 submits a request for a status update to be forwarded to mobile device 110, when the subscriber becomes available (S250).

Once the subscriber is available, communication server 100 is notified of a change in subscriber's profile and generates an alert to mobile device 110 or other systems connected thereto, indicating the new availability status. This alert notification can be in form of a broadcast to all devices that store the subscriber's profile in memory, or in form of a response to a particular system (e.g., mobile device 110) that is ready to initiate communication with the subscriber.

For example, once the subscriber switches the “meeting mode” to an off state (e.g., 0), then an alert message will be transmitted to mobile device 110, if application software 1122 has previously submitted a request to be notified of the change of availability status. In certain embodiments, changes in the subscriber's profile are stored in a profile database residing in communication server 100, for example. When a caller attempts to initiate communicating with the subscriber, application software 1122 accesses the database records to retrieve the updated subscriber profile information.

As such, various procedures may be implemented, in accordance to one or more embodiments, to notify or update a third party of the availability status of the subscriber. In one embodiment, the update procedure takes place immediately after the subscriber's profile changes. In other embodiments, the updated profile information is transmitted after a predetermined time period has lapsed. This lapse in time prevents multiple update procedures and reduces processing time, in case the subscriber's profile is changed temporarily for a short time, due to system or user error, for example.

In embodiments of the invention, mobile devices 110, 120, communications server 100, service provider servers, and profile servers comprise a controlled computing system environment that can be presented largely in terms of hardware components and software code executed to perform processes that achieve the results contemplated by the system of the present invention. A more detailed description of such system environment is provided below with reference to FIGS. 3A and 3B.

As shown, a computing system environment is composed of two environments, a hardware environment 1110 and a software environment 1120. The hardware environment 1110 comprises the machinery and equipment that provide an execution environment for the software. The software provides the execution instructions for the hardware. It should be noted that certain hardware and software components may be interchangeably implemented in either form, in accordance with different embodiments of the invention.

Software environment 1120 is divided into two major classes comprising system software 1121 and application software 1122. System software 1121 comprises control programs, such as the operating system (OS) and information management systems that instruct the hardware how to function and process information. Application software 1122 is a program that performs a specific task.

Referring to FIG. 3A, an embodiment of the application software 1122 can be implemented as computer software in the form of computer readable code executed on a general purpose hardware environment 1110 that comprises a central processor unit (CPU) 1101, a main memory 1102, an input/output controller 1103, optional cache memory 1104, a user interface 1105 (e.g., keypad, pointing device, etc.), storage media 1106 (e.g., hard drive, memory, etc.), a display screen 1107, a communication interface 1108 (e.g., a network card, a blue tooth port, a modem, or a wireless communication chipset, etc.), and a system synchronizer (e.g., a clock, not shown in FIG. 3A).

Cache memory 1104 is utilized for storing frequently accessed information. A communication mechanism, such as a bi-directional data bus 1100, can be utilized to provide for means of communication between system components. Hardware Environment 1110 is capable of communicating with local or remotes systems connected to a communications network (e.g., a PAN or a WAN) through communication interface 1108.

In one or more embodiments, hardware environment 1110 may not include all the above components, or may include additional components for additional functionality or utility. For example, hardware environment 1110 can be a laptop computer or other portable computing device that can send messages and receive data through communication interface 1108. Hardware environment 1110 may also be embodied in an embedded system such as a set-top box, a personal data assistant (PDA), a wireless mobile device (e.g., cellular phone), or other similar hardware platforms that have information processing and/or data storage and communication capabilities. For example, in one or more embodiments of the system, hardware environment 1110 may comprise a PMG unit or an equivalent thereof.

In embodiments of the system, communication interface 1108 can send and receive electrical, electromagnetic, or optical signals that carry digital data streams representing various types of information including program code. If communication is established via a communications network, hardware environment 1110 may transmit program code through the network connection. The program code can be executed by central processor unit 1101 or stored in storage media 1106 or other non-volatile storage for later execution.

Program code may be transmitted via a carrier wave or may be embodied in any other form of computer program product. A computer program product comprises a medium configured to store or transport computer readable code or a medium in which computer readable code may be embedded. Some examples of computer program products are memory cards, CD-ROM disks, ROM cards, floppy disks, magnetic tapes, computer hard drives, and network server systems.

In one or more embodiments of the invention, processor 1101 is a microprocessor manufactured by Motorola, Intel, or Sun Microsystems Corporations, for example. The named processors are for the purpose of example only. Any other suitable microprocessor, microcontroller, or microcomputer may be utilized.

Referring to FIG. 3B, software environment 1120 is stored in storage media 1106 and is loaded into memory 1102 prior to execution. Software environment 1120 comprises system software 1121 and application software 1122. Depending on system implementation, certain aspects of software environment 1120 can be loaded on one or more hardware environments 1110.

System software 1121 comprises control software, such as an operating system that controls the low-level operations of hardware environment 1110. Low-level operations comprise the management of the system resources such as memory allocation, file swapping, and other core computing tasks. In one or more embodiments of the invention, the operating system can be Nucleus, Microsoft Windows CE, Microsoft Windows NT, Macintosh, or Palm operating systems. However, any other suitable operating system may be utilized.

Application software 1122 can comprise one or more computer programs that are executed on top of system software 1121 after being loaded from storage media 1106 into memory 1102. In client-server architecture, application software 1122 may comprise client software and server software. Referring to FIG. 1 for example, in one embodiment of the invention, client software is executed on mobile devices 110, 120 and server software is executed on the service provider system (not shown) or communications server 100.

Software environment 1120 may also comprise web browser software 1126 for accessing content on a remote server. Further, software environment 1120 may comprise user interface software 1124 (e.g., a Graphical User Interface (GUI)) for receiving user commands and data. The received commands and data are processed by the software applications that run on the hardware environment 1110. The hardware and software architectures and environments described above are for purposes of example only. Embodiments of the invention may be implemented in any type of system architecture or processing environment.

Embodiments of the invention are described by way of example as applicable to systems and corresponding methods that facilitate updating a subscriber's profile. In this exemplary embodiment, logic code for performing these methods is implemented in the form of, for example, application software 1122. The logic code, in one embodiment, may be comprised of one or more modules that execute on one or more processors in a distributed or non-distributed communication model.

It should also be understood that the programs, modules, processes, methods, and the like, described herein are but exemplary implementations and are not related, or limited, to any particular computer, apparatus, or computer programming language. Rather, various types of general-purpose computing machines or customized devices may be used with logic code implemented in accordance with the teachings provided, herein. Further, the order in which the methods of the present invention are performed is purely illustrative in nature. These methods can be performed in any order or in parallel, unless indicated otherwise in the present disclosure.

The methods of the present invention may be performed in either hardware, software, or any combination thereof. In particular, some methods may be carried out by software, firmware, or macrocode operating on a computer or computers of any type. Furthermore, such software may be transmitted in the form of a computer signal embodied in a carrier wave, and through communication networks by way of Internet portals or websites, for example. Accordingly, the present invention is not limited to any particular platform, unless specifically stated otherwise in the present disclosure.

The present invention has been described above with reference to preferred embodiments. However, those skilled in the art will recognize that changes and modifications may be made in these preferred embodiments without departing from the scope of the present invention. Other system architectures, platforms, and implementations that can support various aspects of the invention may be utilized without departing from the essential characteristics as described herein. These and various other adaptations and combinations of features of the embodiments disclosed are within the scope of the invention. The invention is defined by the claims and their full scope of equivalents.

1. A method of communicating with a subscriber of a communication service, the method comprising:
processing contact information provided to a first communication device for establishing a communication connection with a second communication device used by the subscriber;
accessing the subscriber's profile information based on the provided contact information; and
determining an availability status for the subscriber based on the profile information, wherein the profile information is updated in real-time in accordance with at least the subscriber's interaction with the second communication device.

2. The method of claim 1, further comprising:
establishing a connection between the first and second communication devices, when the subscriber is available according to the determined availability status of the subscriber.

3. The method of claim 1, further comprising:
providing an option to send a status update to the first communication device, if the subscriber is unavailable according to the determined availability status of the subscriber.

4. The method of claim 3, further comprising:
monitoring the availability status of the subscriber in real-time; and
sending a status update to the first communication device, when the subscriber becomes available according to a change in the availability status of the subscriber.

5. The method of claim 3, further comprising:
establishing a communication connection with the second communication device, when the availability status of the subscriber changes from unavailable to available.

6. The method of claim 1, wherein the first communication device is a mobile communication device.

7. The method of claim 1, wherein the second communication device is a mobile communication device.

8. The method of claim 1, wherein the subscriber's profile information is stored in the second communication device.

9. The method of claim 1, wherein the subscriber's profile information is stored in a database accessible by the first communication device.

10. The method of claim 1, wherein the subscriber's profile information can be edited by the subscriber.

11. A mobile communication system comprising:
means for processing contact information for establishing a communication connection with a remote communication device used by the subscriber;
means for accessing the subscriber's profile information based on the provided contact information; and
means for determining an availability status for the subscriber based on the profile information, wherein the profile information is updated in real-time in accordance with at least the subscriber's interaction with the remote communication device.

12. The mobile communication system of claim 11, further comprising:
means for establishing a connection with the remote communication devices, when the subscriber is available according to the determined availability status of the subscriber.

13. The mobile communication system of claim 11, further comprising:
means for providing an option to receive a status update, if the subscriber is unavailable according to the determined availability status of the subscriber.

14. The mobile communication system of claim 13, further comprising:
means for monitoring the availability status of the subscriber in real-time; and
means for receiving a status update, when the subscriber becomes available according to a change in the availability status of the subscriber.

15. The mobile communication system of claim 13, further comprising:
means for establishing a communication connection with the remote communication device, when the availability status of the subscriber changes from unavailable to available.

16. The mobile communication system of claim 11, wherein the mobile communication system is a cellular communication device.

17. The mobile communication system of claim 11, wherein the remote communication device is a cellular communication device.

18. The mobile communication system of claim 11, wherein the subscriber's profile information is stored in the remote communication device.

19. The mobile communication system of claim 11, wherein the subscriber's profile information is stored in a database accessible by the mobile communication system.

20. The mobile communication system of claim 11, wherein the subscriber's profile information can be edited by the subscriber.
